(19) United States
(12) Patent Application Publication
(10) Pub. No.: US 2021/0406514 A1
(43) Pub. Date: Dec. 30, 2021

(54) SYSTEM, METHOD, AND WRITING APPARATUS FOR RECORDING USER BIOMETRIC INFORMATION DIRECTLY ONTO DOCUMENTS

(71) Applicant: Suresign Technology LLC, Cary, NC (US)

(72) Inventor: Patrick O'Neal Nunally, Escondido, CA (US)

(21) Appl. No.: 17/361,296

(22) Filed: Jun. 28, 2021

Related U.S. Application Data
(60) Provisional application No. 63/102,730, filed on Jun. 29, 2020.

(51) Int. Cl. G06K 9/00

(52) U.S. Cl. CPC G06K 9/00187; G06K 9/00442; G06K 9/00174

(57) ABSTRACT

A system, method and writing apparatus disclosed herein enables a physical handwritten mark (such as “wet” signature) to be encoded with user biometric characteristics which are unique to the person making the handwritten mark. A system and method are described that may utilize a signature created by the writing apparatus.

### CLAIM TO PRIORITY UNDER 35 U.S.C. § 119

The present application for patent claims the benefit of U.S. Provisional Application No. 63/102,730 filed on Jun. 29, 2020, entitled, “SYSTEM, METHOD, AND APPARATUS FOR RECORDING USER BIOMETRIC INFORMATION DIRECTLY ONTO DOCUMENTS,” of which is owned by the Applicant and expressly incorporated herein by reference in its entirety.

### FIELD

The disclosed embodiments relate to a system, method, and writing apparatus for recording user biometric information directly onto documents.

### BACKGROUND

Some attempts have been made to encode user biometric information within handwritten signatures. However, unintentional vibrations that may cause the pen tip to be inertially raised off the page, may create unintentional breaks in the handwriting, which may produce significant distortions in the shape of the signature and significant smearing of the ink marks along the path of signature resulting in inconsistent signature shape and marks. There is a need in the art for a method, system, and apparatus to be able to encode directly onto a document user biometric information without distortion of the natural handwritten signature.

Moreover, the current capturing and verification of digital signature attributes have been limited to the direct input of the signature with a digital device (via electronic input pads, wireless connected writing instruments, etc.). The collection of handwriting metrics through specially designed peripherals draws data directly into computational devices for processing and authentication, but does not address the need for, nor the utilization of, the authentication of the original “wet” signature itself on the document. Thus, there is a need in the art for signature verification directly embedded on original documents that may also be later authenticated, stored, processed, and utilized electronically.

### SUMMARY

Methods, systems, and apparatuses for recording user biometric information directly onto documents are described. In an embodiment, a writing apparatus, for recording user biometric information, is described comprising: a writing tip, the writing tip comprising a first material section and a second material section; a motor, the writing tip attached to the motor, the motor configured to rotate the writing tip around its longitudinal axis; an internal power source, the internal power source configured to power the motor; an on/off mechanism, the on/off mechanism configured to turn on and off the writing apparatus; and a tubular housing configured to house the writing tip, the motor, the internal power source and the on/off mechanism.

### BRIEF DESCRIPTION OF THE DRAWINGS

The following embodiments may be better understood by referring to the following figures. The figures are presented for illustration purposes only, and may not be drawn to scale or show every feature, orientation, or detail of the embodiments. They are simplified to help one of skill in the art understand the embodiments readily, and should not be considered limiting.

FIG. 1 illustrates how a user's writing process may be exploited by a writing device in an embodiment.

FIG. 2 illustrates a writing apparatus that encodes user biometrics in an embodiment.

FIG. 3A illustrates a typical “wet” signature.

FIG. 3B illustrates a signature made using a writing apparatus in an embodiment.

FIG. 4A illustrates a writing apparatus in an embodiment.

FIG. 4B illustrates a writing device with a different view in an embodiment.

FIG. 4C illustrates an embodiment of a writing tip.

FIG. 5 illustrates a verification method in an embodiment.

FIG. 6 illustrates a verification and registration method in an embodiment.

FIG. 7 illustrates a system for the registration and verification processes in an embodiment.

### DETAILED DESCRIPTION

The system, method and writing apparatus disclosed herein enables a physical handwritten mark (such as “wet” signature) to be encoded with user biometric characteristics which are unique to the person making the handwritten mark. Signature, herein, meaning any handwritten mark, word, phrase, name, symbol, or element. The biometric characteristics may in turn be used to authenticate a signing individual based on the physiological and behavioral characteristics of the signing individual's stroke speed interacting with the writing device. The writing device may deposit (encode or embed) the signing individuals' biometric characteristics into their signature onto the page while preserving their mark's physical appearance. The resultant document will not only bear the authorizing signature, but certain biometric mark attributes that are unique to the signatory. Thus, the disclosed embodiments enable biometric encoding of handwritten signatures written on paper without the need for computational infrastructures or material changes in business processes which require standard ink signatures (wet signatures). The writing apparatus may embed a user's biometric characteristics without distortion of their signature.

Moreover, the described system and method may utilize the writing apparatus' recorded biometric information for authentication, etc. Spatiotemporal signature verification as disclosed herein (“STSV”) may use the behavioral biometrics of a hand-written signature to validate the identity of a given signature. Please note, a distinction between simple static signature comparison and dynamic signature verification. Both can be computerized, but a simple signature comparison only takes into account of the appearance (shape) of the signature. Dynamic signature verification (“DSV”) takes into account the process of how the signature was formed. With dynamic signature verification, not only is the shape or look of the signature is meaningful, but also the changes in speed and timing that occur during the act of signing that are unique to the signatory (e.g. speed of a downstroke, pauses between letters, etc.). Only the original signer can recreate the changes in these timings and speeds (e.g. their unique mechanics of physically writing) during the signing process.

A writing instrument, as described herein, may interact with the original signer's unique handwriting mechanics (e.g. speed of a downstroke, pauses between letters, etc.), such that, it encodes a visual/or detectable pattern embedded in their “wet” signature. The recorded interaction may be created multiple ways. In an embodiment, depositing a single material at a predetermined rate may be used. In another embodiment, alternating the color, contents, or nature of the material at a fixed rate may be used (e.g. more than one material). For example, two types of metal alloys may be used. A first metal alloy may transfer a small amount of alloy from the pen tip to the page, for example Lead, while the second metal alloy which differs from the first alloy in color, boldness, etc. may transfer a small amount of the second alloy on the page. It is the Applicant's intention that various mechanisms may be used by the writing instrument to exploit a signer's unique signing attributes, and is envisioned within the scope of this disclosure. A fixed, variable, cyclic and/or patterned timing of at least one marking type (color, continuity, offset, material type, thickness, material, chemical, texture, and/or contrast) may be used.

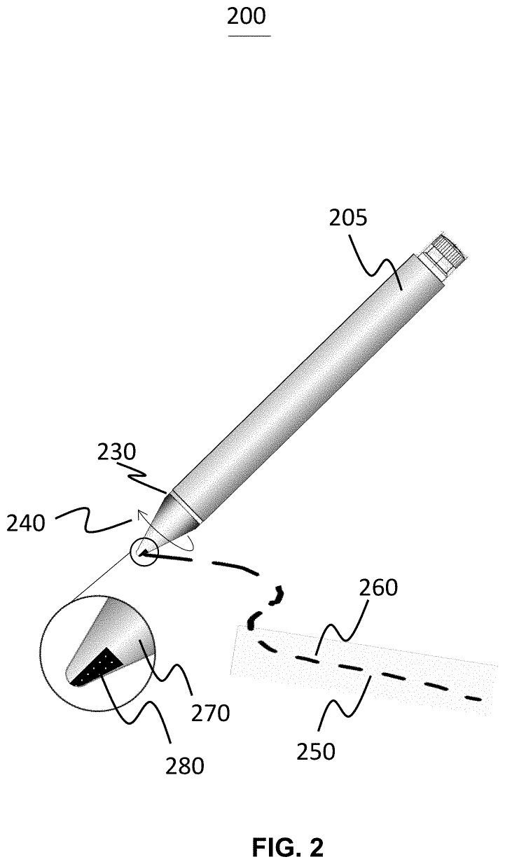

FIG. 2 illustrates a writing apparatus 200 that encodes user biometrics in an embodiment. In an embodiment, writing apparatus (200) may use a dual metal alloy and tip (230, 475). The writing tip (230) may be configured with at least two marking material types (270)(280) which is shown here as light-colored material (270) and dark-colored material (280). The at least two material types are configured to each make up one half of the marking tip. In an embodiment, the at least two materials may have equal shares in the upper 5-20% of the tip cone. In an embodiment, the at least two materials may have equal shares for the entire tip cone. Writing tip (230) may be constructed to be a permanent, but replaceable, part of the writing device (200), or it may be constructed to be temporary type of re-fillable tip. When the dual material tip comprised of a first metal alloy (280) and a second metal alloy (270) is rotated around the pens longitudinal axis at a fixed rate (240) by an internal motor, and is moved at a mutable speed across a document by a user, the writing device (200) may create a mark (e.g. signature) comprised of two materials (e.g. shown for clarity as a “dashed” line where the dashes (260) represents one of the metal alloys (280) and the blank area between the dashes represents the other metal alloy (270).

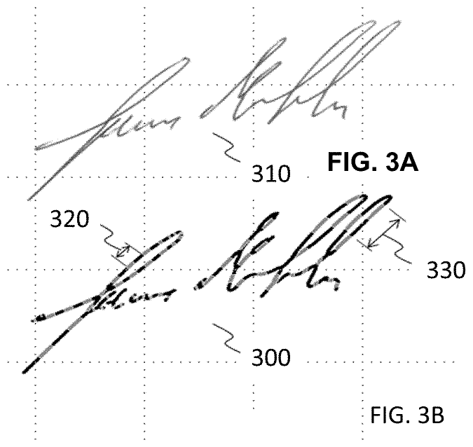

A signature executed with the writing apparatus may result in a signature made up of dashed lines or alternately of varying color/composition. FIGS. 3A and 3B helps to illustrate this. FIG. 3A is an example of a typical signature (310) with typical solid lines. In contrast, FIG. 3B illustrates the same signature (300) made with a writing device in an embodiment. The detectable embedded pattern (320, 330) may be made blatant or less noticeable to the human eye. A writing apparatus, in an embodiment, may be designed to create a smooth and virtually indistinguishable form of a person's signature. However, when examined at a suitable level of magnification or with instrumentalities, such a signature may reveal the biometric information that may confirm the identity of the signatory.

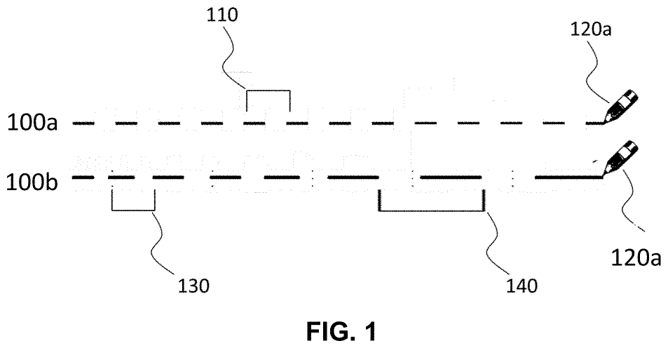

The writing instrument (e.g., a pen) in an embodiment, may have a function which creates breaks (or changes) in the depositing of “ink-like” material onto a paper page at a fixed rate of time (typically between 20-200 milliseconds). Ink-like material, herein, may comprise any material suitable for use with the writing device (400) for leaving a permanent or semi-permanent mark on paper. For example, the material typical coloring pencils are made of: pigment, binders, and extenders, or some polymers. The rate of change creates a noticeable pattern in the mark left by the apparatus (when used) which is directly related to the velocity and/or acceleration of the apparatus marking tip. For exemplary purposes, applicant will focus on the broken line alternative as it is the easiest to illustrate. Similarly, for illustrative purposes applicant will exaggerate the length of time between transitions to roughly 100 milliseconds between marking and non-marking transitions to better illustrate the operation and functionality of the apparatus, and so that the calculations in the examples offered herein can be made simple. The effect of transitioning between at least two materials at a fixed period of time or known pattern/intervals (in this example 100 milliseconds) results in a variable indirect recordation of user stroke speed. For example, using the apparatus described herein to make a straight one-inch mark over a consistent 1 second period of time will result in a one-inch mark with 20 material transitions deposited on the page where the length of each material segment may be 0.05 inches. Using the same apparatus transitioning at the same fixed period of time (in this case 100 milliseconds) to make a straight five-inch mark over a consistent one second period, will result in a five-inch mark with 20 material transitions deposited. However, in this case the length of each material segment may be 0.25 inches. As per these two examples, it should be clear that the velocity as well as the acceleration of the apparatus marking tip (via the user) creates a proportional linear variation in the length of material segments deposited on the page. A slower moving writing device (400) may create shorter more frequently deposited material transitions. While a faster moving writing device (400) may create longer less frequent deposited material transitions. Once the apparatus is used to affix a mark such as a signature on a page, it may be determined, based on the relative fixed rate of material change as well as the length of the mark material or mark material transitions, the relative stroke speed used to make each segment of the mark. In other words, the lengths of mark types deposited may be directly proportional to the velocity that the user moved the marking instrument while signing. The deposited markings may create a time-varied pattern on the page made up of contiguous mark lengths (or transitions) which are unique to the signatory's speed of use of the writing apparatus. FIG. 1 helps to further illustrate this concept.

FIG. 1 illustrates, in an embodiment, how a user's writing process may be exploited by a writing device. The dashes in FIG. 1 are exaggerated for the understanding of the embodiments. Line 100a is shown with a marking transition length of time of 41.6 milliseconds (110). If the writing instrument 120a is moved in a straight line across the page at a constant rate of 150 m/s, then line 100a may be the resulting mark. The mark created by apparatus 120a may be essentially a “dashed—line.” In contrast, line 100b illustrates writing device 120a being moved from left to right at a constant acceleration of 450 m/s2 to start with (130), but accelerates more than 450 m/s2, resulting in a measurable change in the lengths and deposited times of the dashed lines (140). The two lines 100a and 100b illustrate how changes in the user's pen movements creates measurable differences in the dashed lines.

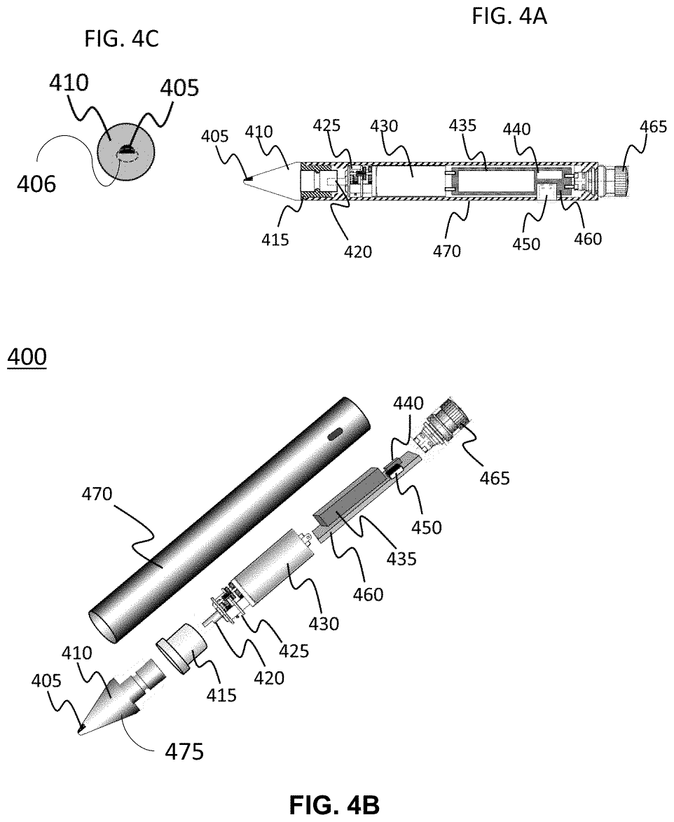

FIG. 4A, illustrates a writing device (400), in an embodiment, which may leave at least two differing marking material types. FIG. 4B illustrates a writing device 400 with a different view in an embodiment. Writing tip (475) may be rotating at a fixed rate by an electronic motor (430). Writing instrument (400) may create changes in the depositing of marking material onto a page at a fixed rate in time (typically 20 milliseconds). This rate of change creates a noticeable pattern in the mark left by the pen (400) which is directly related to the speed at which the mark was made. The apparatus (400) may have a tubular housing (470) which is operatively structured as a writing instrument and functions to house the internal circuits and mechanisms. Tubular housing may be made from plastics, wood, metals, etc. and be configured to open or separate (removably/separated securable) as is well known in the art. The writing tip (475) may include a first material section (405) which may be inlayed into a second material section (410). FIG. 4C illustrates an embodiment of a writing tip (475) where three marking materials are used. Marking material 406 may be opposite material 405 while the rest of the tip uses another material 410. Other configurations of using more than one marking materials are possible. For example, three marking materials may each share a third of the tip's cone. In an embodiment, writing tip assembly (475) may be positioned to be rotated around its longitudinal axis through a tip connection (420) attached to an optional micro gear assembly (425). Attached, herein, meaning joined or connected to, but may be in a linking, indirect or direct manner, and may be attached internally or externally. The micro gear assembly (425) may be configured to reduce a motor's (430) natural revolutions. For example, micro gear assembly (425) may be configured to effectively reduce motor (430) revolutions of the writing tip to 45 revolutions per minute. Motor (430) may be configured to rotate at the desired revolutions per minute without using micro gear assembly (425). Internal motor (430) may be powered by a power source such as a rechargeable battery pack (435) and may be activated by an on/off mechanism (465). The on/off mechanism may be mechanical switch, a thermal switch, a rotational switch, a conductive switch, an inductive switch, and a light sensitive switch, an electrical switch or any combinations thereof. When activated by the on/off mechanism (465) a power source (435) may be configured to supply power to the motor (430) which may be geared down by the micro gear assembly (425) by a factor of 10 and may in turn rotate the motor shaft (420) at 45 rpm. The motor shaft (420) may be attached to the pen tip assembly (475). The assembly may be allowed to freely rotate using a bearing washer (415) to reduce friction. The bearing may be made from any suitable material, for example, Teflon. Writing device (400) may be recharged using an external common USB-c power supply. A USB-c connector housed in the apparatus (450) may be used to connect to an external power source. Apparatus (400) may also contain power conditioning and control circuitry which may include capacitors (440) and diodes (460).

In an embodiment, writing apparatus (400) may employ a metallic marking tip (475) comprised of at least two distinct metal alloys used for marking on a page. These two metal alloys may be conformal deposits on a separate metallic core. Metallic marking metals may include one metal alloy type of about (about herein meaning each element in the mixtures may tolerate 5% plus or minus error as well as some trace amounts of elements not listed) 65 parts tin), about 30 parts bismuth, about 5 parts gallium and a second metal alloy of about 58 parts tin, about 40 parts bismuth, about 2 parts aluminum. These metal alloys may be patterned vertically each on one half of the cone shaped marking tip (405 and 406). The marking tip (475) may be rotated in a counterclockwise or clockwise fashion at a fixed rate. Looking downward from the device end (device “end” herein being the end opposite the tip) on the writing device (400) towards the tip (475), a clockwise direction would be going from 90° to 0° on a polar coordinate system. While the fixed relative rate may be important, the absolute speed may not be critical, so long as it is a fairly constant rate (marking variations are dependent on relative (not absolute) rates of change. Other alloys (405 and 406) may be used including combinations of about 60 parts tin, about 38 parts bismuth, about 2 parts gallium, or about 37 parts tin, about 60 parts bismuth, about 1 part gallium, and about 2 parts aluminum, or about 58 parts tin, about 40 parts bismuth, and about 2 parts aluminum. The elements in the alloys listed may be cast into a cylindrical ingot using vacuum induction melting at 125˜150 C followed by at least 60 minutes of annealing at 80 C. In an embodiment, aluminum may be cast into the form of the second metal alloy section (410 and 406) and Lead may be inlayed into the conical half of the first metal alloy section (405). These materials may be annealed onto a mechanically harder metal core for added strength in the marking tip especially if it rotates. Once a signature has been embedded with its signatory's unique biometrics, it may be further used in verification systems.

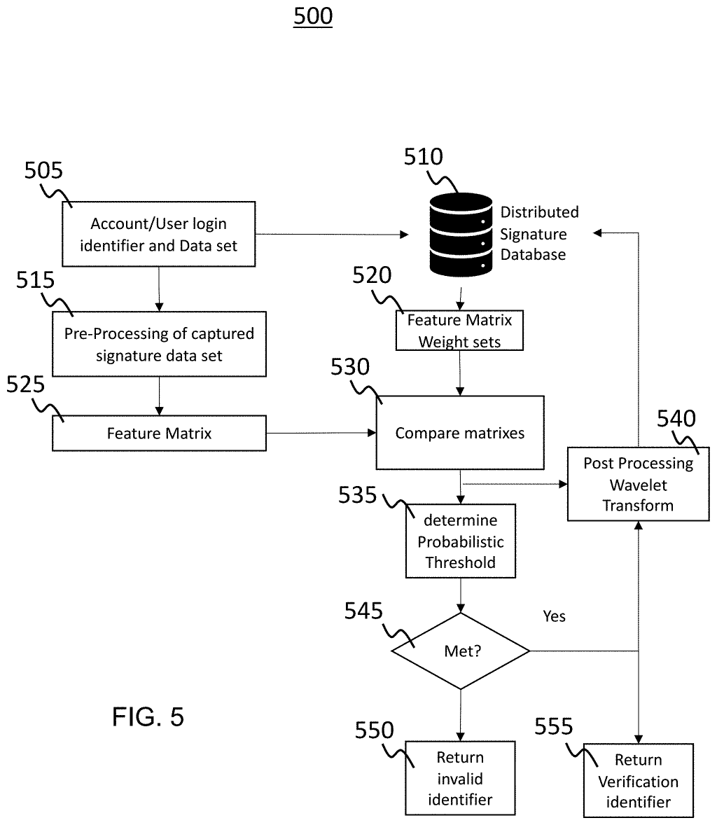

The resultant mark may be validated visually or with digital imaging processing. The resultant mark created by the use of the writing apparatus may also be validated as illustrated in FIGS. 5, 6, and 7 according to the following broad processing steps: 1) collection and enrollment of several STSV sample signatures using the apparatus, 2) conversion of the sample signatures to a biometric template, 3) presentation of additional STSV sample signatures using the apparatus data from the person to be verified, and 4) comparison of templates to calculate a similarity score, in order to determine whether a newly acquired test signature represents the same individual as stored signatures from that individual. Many known algorithms may be adapted for analysis of the resultant markings of the apparatus with varying levels of accuracy. While the prior art for dynamic signature verification is rich with algorithms which require a real-time capture of dynamic inputs as they are made, these algorithms were developed largely for analysis of human signatures directly captured by electronic devices. These methods of electronic capture have been of limited use because they require considerable infrastructure support of pads an like mechanisms to electronically capture and record signatures. Validation of the signature marking of the apparatuses by one or more of the existing digital signature verification algorithms requires an interim conversion API of the mark information as dictated by the existing digital signature verification algorithms. The disclosed embodiments present novel methods to encode physical markings on a page with spatiotemporal information, methods to normalize the signature and extract the temporal information, and systems to verify the signature, all of which may significantly improve the field. In an embodiment, a method of pre-processing handwritten information is disclosed that may provide a common normalization of signature presentation to allow compatibility with an array of signature validation methods which are optimized to the verification algorithm desired. While many variations are possible, normalization may be consistent between training and verification/authorization.

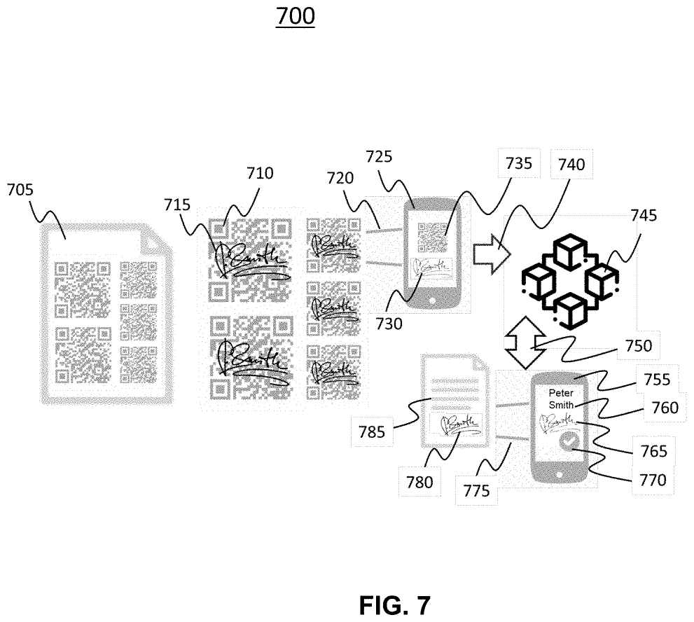

A verification method 500, in an embodiment, is illustrated in FIG. 5. As shown, users may log into a verification system with preregistered credentials and a signature identifier in the form of an account (505). A dataset representing the captured signature data may be used at the login stage as well. The preregistered credentials allow access to the distributed database and the signature identifier may be used to index the distributed signature database (510). Based on the identifier sent to the server (510) the corresponding feature matrix in the form of a weight set (520) may be selected from the database (510). The sample signatures may be captured and extracted from their model format (515) and features of the signature including shape and relative length of mark transitions may be formatted as a feature matrix (525). The features extracted from the captured signature may be processed for conformity (530) by comparing the feature matrixes using the indexed weight set (520) resulting in a measurement of correlation. Transition points gathered in dynamic time warping in coordinates measurements from the centroid (polar coordinates) as described in FIG. 7 may be used. A Naïve Bayesian Tree may be used in an embodiment at step 530, to perform a classification of the correlation between the sampled signature and the previous samples, for example, but other known method may also be used. At step 535, the results of step 530 are determined to be met by a probabilistic threshold. At step 545, if the correlation is found to be above or equal to a predefined threshold (535) (for example a probabilistic threshold (535) set to 95%), then the process may return an indication of a validation of the signature (555). Once correlation has been measured and a valid signature is determined, then the database may be refined based on a wavelet revision (540), If the correlation (535) is found to be below a predefined threshold (for example below 95%), then the process returns an indication of an invalidation of the signature (550). The process may indicate how much of a mismatch there was between the feature matrix and the featured matrix weight set/s. For example, if may indicate it was 94%, or 30%.

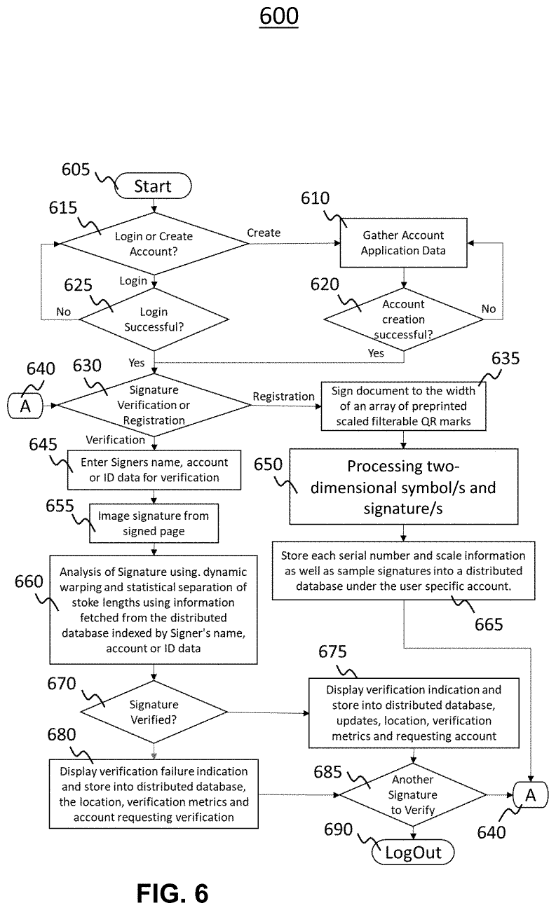

FIG. 6 illustrates a verification and registration method 600 in an embodiment. Once the process is initiated (605) a user may be allowed to login into a preexisting account (625) or to create an account (615), If the user chooses to create an account, account data such as name, address, email address, mobile number, etc. may be gathered (610). The user may be verified as is well known in the art (e.g. sending the user a text message or email to confirm their contact information). When the account creation is determined to be complete, the account may be established (620). If the account creation is determined to be incomplete, then additional information may be requested/gathered (610). Once login (625) or account creation (620) is complete, then the user may be asked if they would like to register a signature to their account or verify a signature registered to an account (630). If signature registration is selected, then the user may be instructed to sign a preprinted registration page (705). Next at 650, the sample signatures may be captured by a computing device (725) application where a two-dimensional symbol may be used. In an embodiment, a two-dimensional symbol may be pre-scaled. For example, a pre-scaled QR mark may be physically two inches by two inches on the registration page. It may be a pink (or red toned color). The registration page may comprise more than one type of pre-scaled QR mark. The size of the pre-scaled QR mark (710) may be embedded in its code, such that when read, it will inform the reader of its actual physical size. By having a handwritten signature on top of a two-dimensional pre-scaled symbol/s, it may provide an accurate scale of the signature not dependent on the camera's/scanners distance from the page etc.: resolution, serial numbers and scale are inherent in the image capture (720), Each serial number and scale information as well as sample signatures captured (720) by a device (725) may be stored (740) into the distributed database indexed to the user specific account (665) (745). Once a signature is indexed and stored (665), the user may be returned (640) to the function request (630).

If verification of a signature is selected (630), then an identification of the claimed signatory may be entered (645) for the verifying client (755). In the case of the verification function request, the professed signature may be digitally imaged from the signed page (655) (785). The captured professed signature may be analyzed considering data derived from the sample signatures indexed to the identification of the claimed signatory entered (e.g. database 510, 665, 745) for the verifying client (755). If the signature is verified (670), then a verification indication (770) may be displayed on the verification client device (755) and stored into both the distributed database (745) account ledger of both the verifiers account and the verified signor account along with, the location, verification metrics and account requesting verification. If signature verification fails at step 670, then then a failure indication may be displayed on the verification client device (755) and stored into both the distributed database (745) account ledger of both the verifiers account and the verified signor account along with, the location, verification metrics and account requesting verification. Once a signature is verified (675) or fails (680) then the client user may be asked if they have any additional signatures that they would like to verify (685). If there is an additional signature to be validated, the system returns (640) the client device to the main function selection query (630). If no further functions are required, the client device may be logged out of the system (690).

FIG. 7 illustrates a system 700 for the registration and verification processes in an embodiment. A preprinted or a downloadable printable file comprising a blank signature registration page (705) may be provided for the capture and registration of sample signatures into an account. The signature registration page 705 may use any two-dimensional symbols or pre-scaled symbols to capture the sample signatures. The two-dimensional symbols may be expressed as a watermark or in the paper's background (e.g. symbols are able to be separated from signature). In an embodiment, QR marks may be used as the two-dimensional symbol/s. QR marks may be scaled and printed/embedded on the signature registration page (705). Ink color (color or grayscale) may be used as separation means as a simple color filter may be used on the imaged (720) with signature (715) and QR mark (710) to separate the QR mark (735) from the sample signature (730). The captured QR mark may encode a predefined scale so that the resolution and measure of the captured signature (730) may be determined. A standard coordinate system may be used to measure the signature stroke transitions/segments. A polar coordinate system may be used in an embodiment. The centroid of the signature may be used as the origin. Mapping of the segment lengths (e.g. radian measurements of degrees from a horizontal average) may return mark coordinates representing regular interval of change. For example, using known imaging techniques, the edge detections of the line segment mark transitions may be found. Calculating the distance from the signature center (origin) to those edge points may produce a relative coordinate number. A signature's transition edges may be mapped (points representing the entire signature) and those relative numbers stored in the form of a matrix. Times between points of different marking material transitions may be interpolated and stored in a matrix. The edges may be made sharper by way of filtering techniques. For example, a basic process may involve computing temporal distance as follows: for example, the signature being validated may be known as “S;” the exemplar weight set resultant from dynamic time warping and cxxx Ei is used to filter against the sample S. (A) Ei may be rescaled to the same size as S, but do not alter the aspect ratio of Ei. Some size variation may therefore remain. (B) Because Ei has changed size, the time needed to draw it should change also. Based on the ratio of old arc length to new, a new value may be computed for the time needed to draw Ei. (C) coordinates for both S and Ei may be converted from those relative to a fixed capture time relative to the centroid of each signature. (D) the time interval needed to draw S may be divide into a fixed number of smaller intervals. For each subinterval, the (x,y) position of the pen tip may be calculated for both S and Ei. The distance between these two points may be determined, and the sum of these distances in d accumulated. The distance between S and Ei may be d/(common time), which may be a metric of correlation. The captured signature (730) and metrics derived from the QR mark (735) (740) may be stored into a distributed database (745) which may also be indexed to the account of the user registering their signatures.

A biometric encoded signature document (785) may contain a signature written with the writing device 400. The biometric encoded signature document may be verified with the methods, systems, devices as disclosed herein. An unverified signature (780) may be digitally imaged (775) and sent to a verifier's device (755). The signatory indicator (e.g. name, ID, account No., scanned fingerprint) may be entered (760) and associated with the image (776). Once the signatory indicator is entered (760) and the unverified signature is imaged (765), then the request for varication against the distributed database (745) can be made. If the signature is verified, then a verification indication of the signature is displayed (770). System 700 shows mobile devices, but any computing device/s, applications and communication means may be used as is well known in the art.

What is claimed is:

1. A writing apparatus, for recording user biometric information, comprising:
a writing tip, the writing tip comprising a first material section and a second material section;
a motor, the writing tip attached to the motor, the motor configured to rotate the writing tip around its longitudinal axis;
an internal power source, the internal power source configured to power the motor;
an on/off mechanism, the on/off mechanism configured to turn on and off the writing apparatus; and
a tubular housing configured to house the writing tip, the motor, the internal power source and the on/off mechanism.

2. The writing apparatus of claim 1, wherein the first material section comprises a first metal alloy and the second material section comprises a second metal alloy.

3. The writing apparatus of claim 2, wherein the first metal alloy comprises
about 65 parts tin, about 30 parts bismuth, about 5 parts gallium; and
the second metal alloy comprises about 58 parts tin, about 40 parts bismuth, and about 2 parts aluminum.

4. The writing apparatus of claim 2, wherein the first metal alloy comprises
about 60 parts tin, about 38 parts bismuth, and about 2 parts gallium and the second metal alloy comprises about 37 parts tin, about 60 parts bismuth, about 1 part gallium, and about 2 parts aluminum.

5. The writing apparatus of claim 2, wherein the first metal alloy comprises
primarily lead and the second metal alloy comprises primarily aluminum.

6. The writing apparatus of claim 1, Further comprising:
a bearing washer, the bearing washer placed between the writing tip and the tubular housing.

7. The writing apparatus of claim 1, wherein the on/off mechanism may be a mechanical switch, a thermal switch, a rotational switch, a conductive switch, an inductive switch, and a light sensitive switch, an electrical switch or any combinations thereof.

8. The writing apparatus of claim 1, Further comprising:
a micro gear assembly attached between the writing tip and the motor;
the micro gear assembly configured to reduces the motor's effective rotation to 45 revolutions per minute.
